(19) United States
(12) Patent Application Publication
(10) Pub. No.: US 2009/0217774 A1
(43) Pub. Date: Sep. 3, 2009

(54) Torque sensing apparatus

(76) Inventors: Colin Sills, Cambridge (GB); Victoria Clark, Cambridge (GB); Stefan Rühl, Werne (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/921,086

(22) PCT Filed: May 30, 2006
(86) PCT No.: PCT/GB2006/001962

§ 371 Date: Mar. 16, 2009

(30) Foreign Application Priority Data
May 27, 2005 (GB) 0510961.6

(51) Int. Cl. G01L 3/10

(52) U.S. Cl. 73/862.193

(57) ABSTRACT

There is described an apparatus for providing rotary displacement information indicative of the torque applied to a torsion bar which is rotatable relative to a housing, in which the electromagnetic coupling between a transmit aerial fixed relative to the housing and a receive aerial fixed relative to the housing varies in dependence upon first and second resonators fixed to the torsion bar at spaced axial positions. The first and second resonators have respective different resonant frequencies to enable the signal coupled between the transmit aerial and the receive aerial via the first resonator to be distinguished from the signal coupled between the transmit aerial and the receive aerial via the second resonator.

This invention relates to the sensing of position or speed, and has particular, but not exclusive, relevance to a system for measuring torque and component parts thereof.

Torque measuring systems are employed, for example, in automobiles for measuring the torque applied to rotating members such as the steering wheel. In order to measure torque, relative rotary displacement between two points along the axis of rotation of a torsion bar is measured.

Inductive sensors have been used in the past for non-contact position measurement. The present invention addresses techniques for the incorporation of inductive position sensing in a torque sensor.

According to an aspect of the present invention, there is provided apparatus for generating rotary displacement information indicative of the torsion applied to a torsion bar which is rotatable relative to a housing, in which the electromagnetic coupling between a transmit aerial fixed relative to the housing and a receive aerial fixed relative to the housing varies in dependence upon first and second resonators fixed relative to respective spaced axial positions of the torsion bar. The first and second resonators have respective different resonant frequencies to enable the signal induced in the receive aerial by the first resonator to be distinguished from the signal induced in the receive aerial by the second resonator.

An embodiment of the present invention will now be described with reference to the attached figures in which:

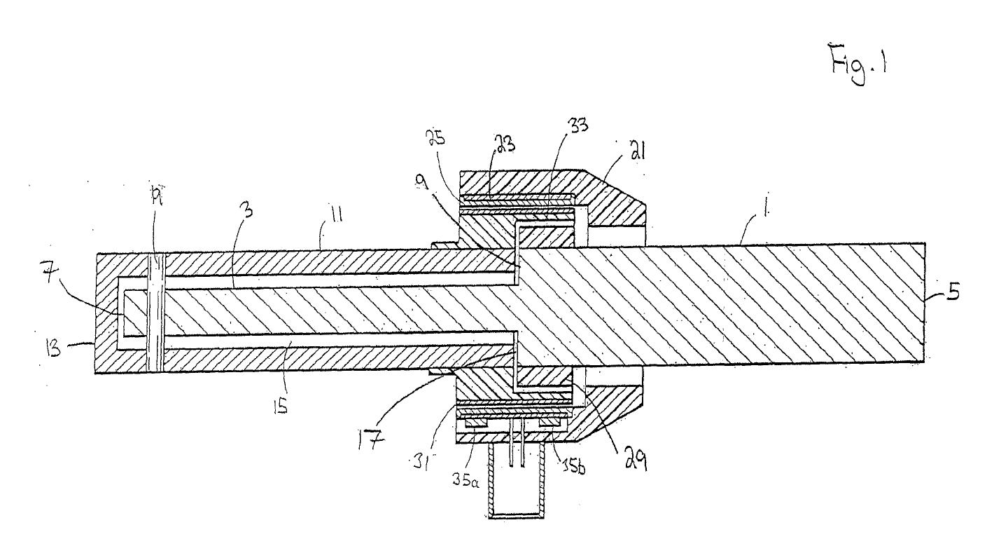

FIG. 1 schematically shows a sectional view of a coupling arrangement between a steering wheel and a gear of a rack-and-pinion type steering mechanism;

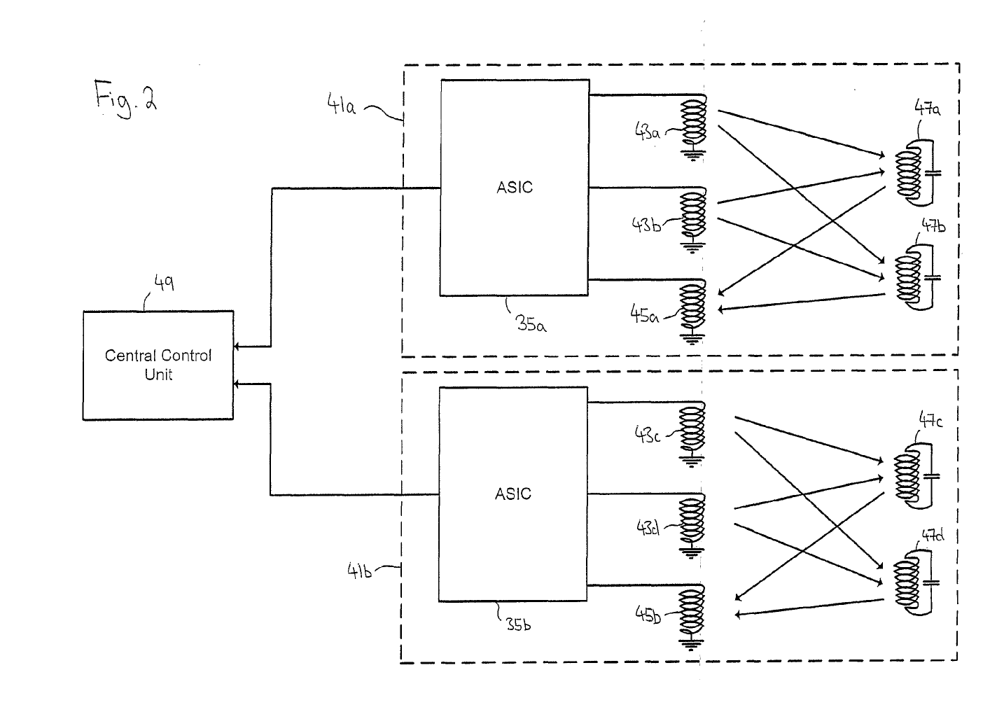

FIG. 2 schematically shows the main components of a position sensor forming part of the coupling arrangement illustrated in FIG. 1;

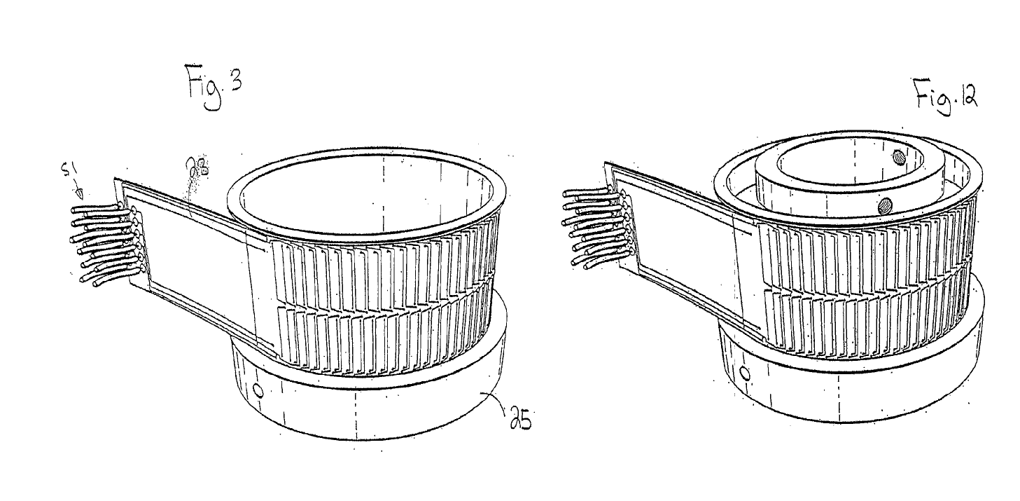

FIG. 3 shows a perspective view of a sleeve member, having mounted thereon a flexible printed circuit board, forming part of the coupling arrangement illustrated in FIG. 1;

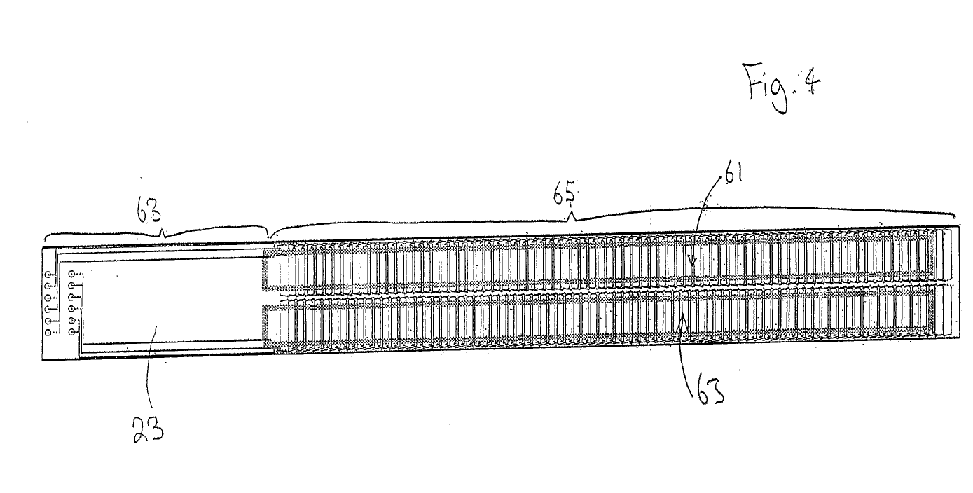

FIG. 4 shows a plan view of the flexible printed circuit board illustrated in FIG. 3 when laid out flat;

FIG. 5 shows a perspective view of a first puck wheel, having mounted thereon a flexible printed circuit board, forming part of the coupling arrangement illustrated in FIG. 1;

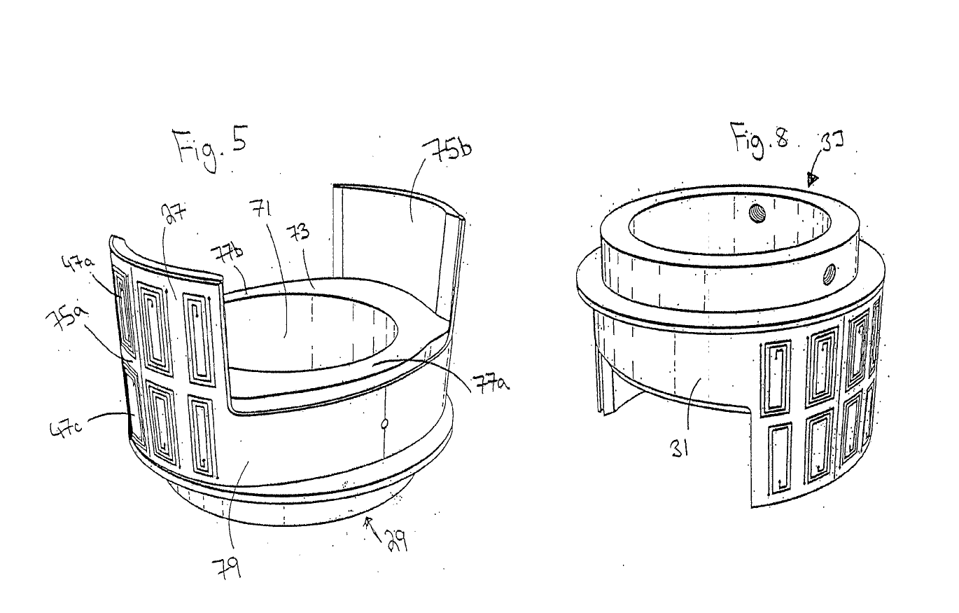

FIG. 6 shows a plan view of the first puck wheel illustrated in FIG. 1;

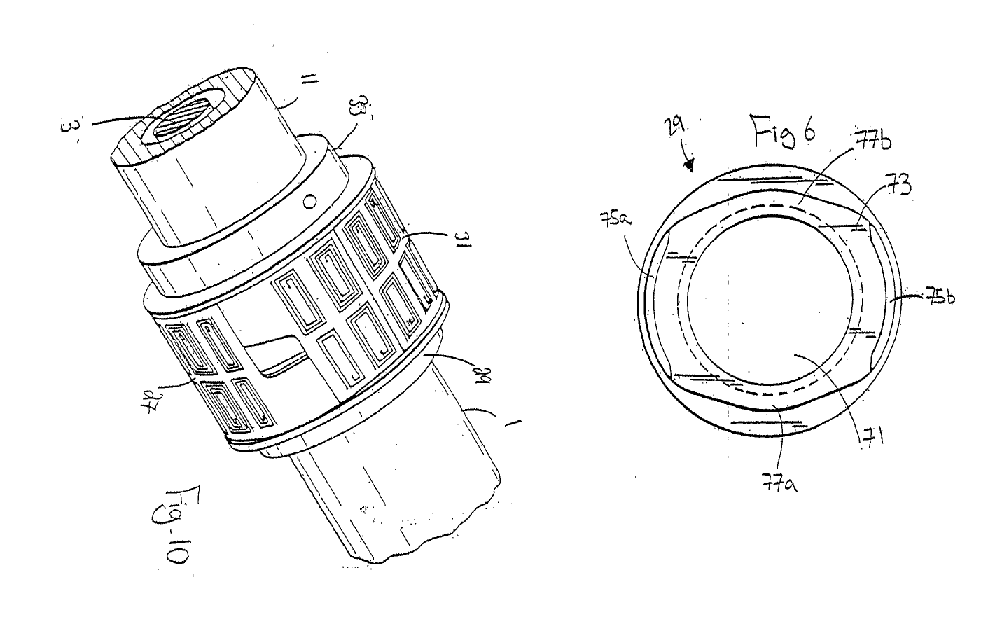

FIG. 7 shows a plan view of the flexible printed circuit board illustrated in FIG. 5 when laid out flat;

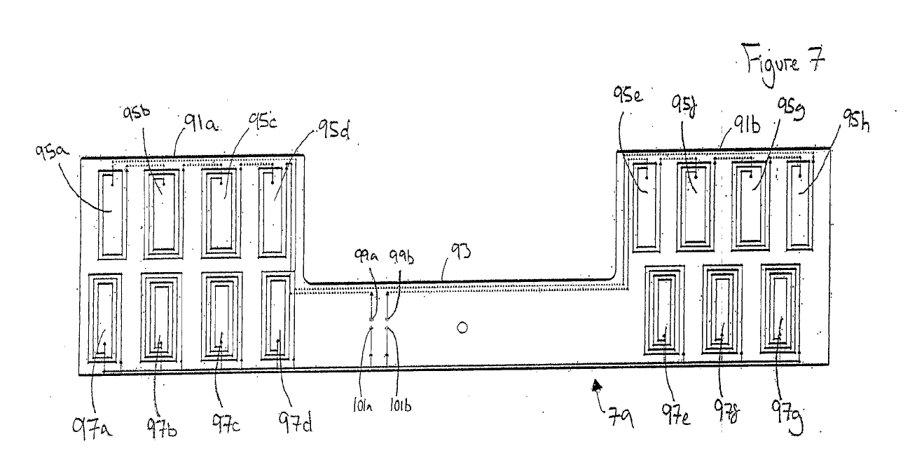

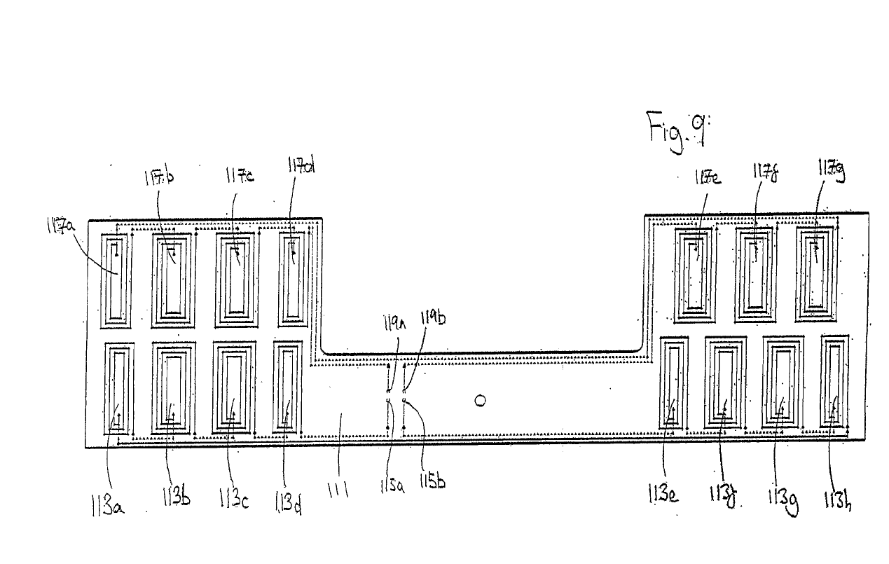

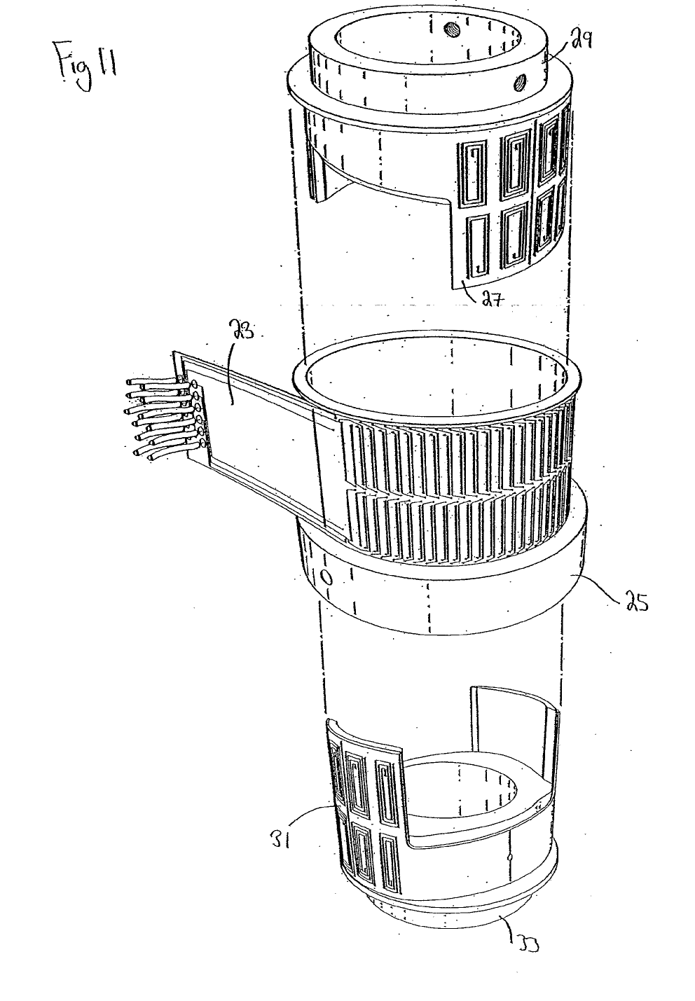

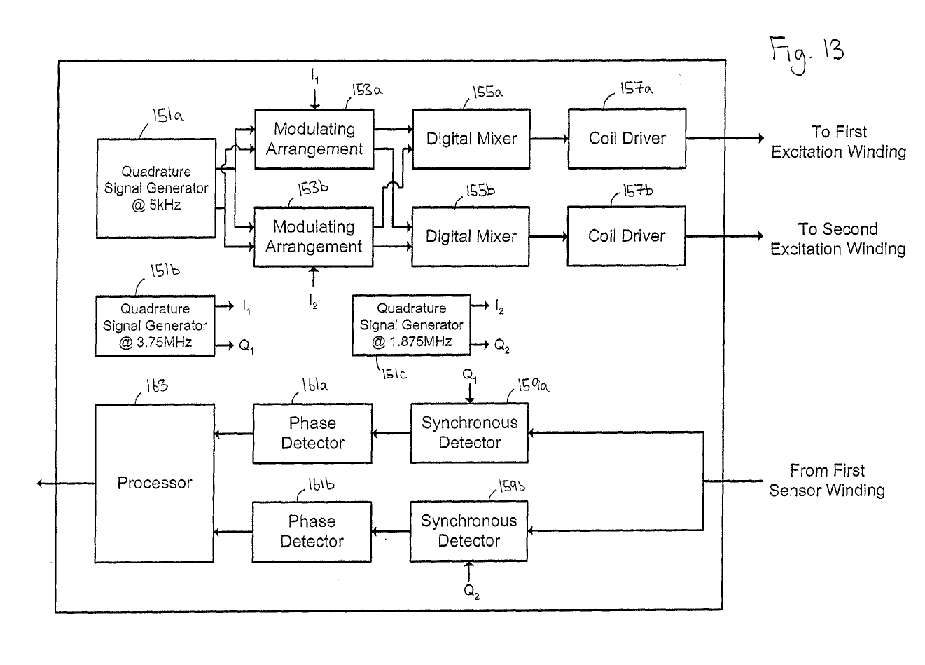

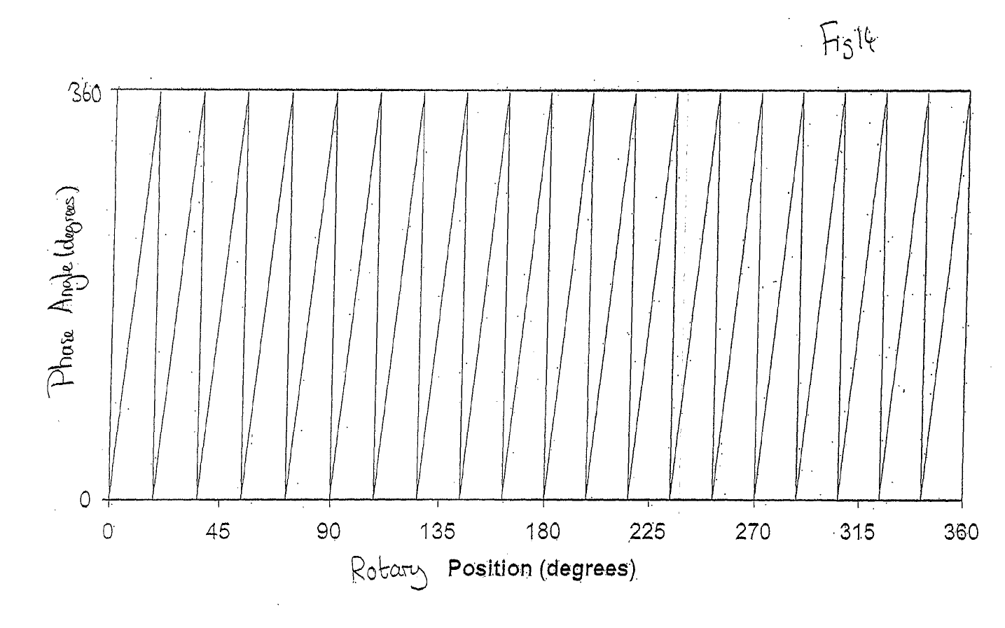

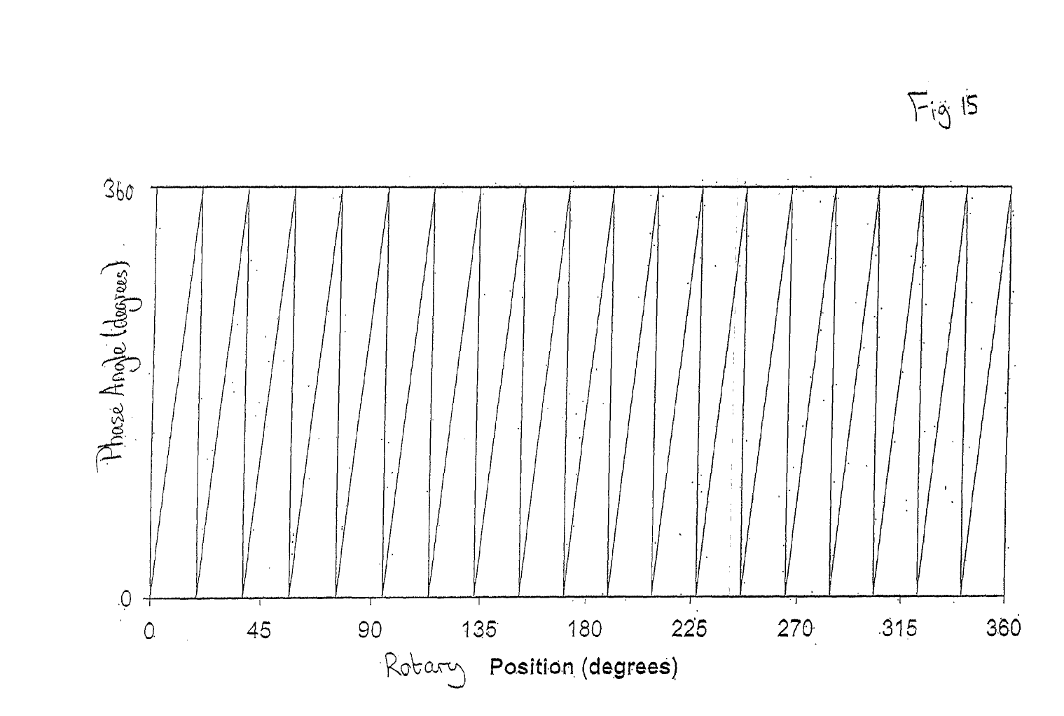

FIG. 8 shows a perspective view of a second puck wheel, having mounted thereon a flexible printed circuit board, forming part of the coupling arrangement illustrated in FIG. 1;

FIG. 9 shows a plan view of the flexible printed circuit board illustrated in FIG. 8 when laid out flat;

FIG. 10 schematically shows a perspective view of the positional relationship between the first and second puck wheels when mounted in the coupling arrangement illustrated in FIG. 1;

FIG. 11 schematically shows an exploded view of the positional relationship between the sleeve, the first puck wheel and the second puck wheel;

FIG. 12 shows a perspective view of the positional relationship between the sleeve, the first puck wheel and the second puck wheel when mounted in the coupling arrangement illustrated in FIG. 1;

FIG. 13 schematically shows the main components of an ASIC forming part of the position sensor illustrated in FIG. 11;

FIG. 14 is a graph showing the relationship between a first detected phase angle and the absolute position of a first shaft forming part of the coupling arrangement illustrated in FIG. 1; and

FIG. 15 is a graph showing the relationship between a second detected phase angle and the absolute position of the first shaft forming part of the coupling arrangement illustrated in FIG. 1.

In the illustrated embodiment of the invention, a car has a steering wheel which is connected to a gear forming part of a rack-and-pinion steering mechanism. FIG. 1 shows a cross-sectional view of a coupling arrangement between the steering wheel and the gear.

A first elongate cylindrical shaft 1 is attached at one longitudinal end 5 to the steering wheel (not shown). As shown in FIG. 1, the first shaft 1 has a reduced diameter axial portion 3 extending from the longitudinal end 7 away from the steering wheel to a stepped region 9. A second elongate cylindrical shaft 11 is attached at one longitudinal end 13 to the gear (not shown) of the rack-and-pinion steering mechanism, and has a hollow axial portion 15 extending from the longitudinal end 17 away from the gear, hereafter called the open end 17. As shown in FIG. 1, the reduced diameter portion 3 of the first shaft 1 is mounted in the hollow portion 15 of the second shaft 11 with the first shaft 1 and the second shaft 11 axially aligned and the stepped region 9 of the first shaft 1 being adjacent the open end 17 of the second shaft 11. A locking pin 19 fixes the first shaft 1 to the second shaft 11 towards the end 7 of the reduced diameter portion 3.

For the remainder of this specification, the term axial direction refers to the direction of the common longitudinal axis of the first and second shafts 1 and 11, the term radial direction refers to lines radiating perpendicularly away from the axial direction, and the term circumferential direction refers to a direction normal to both the axial direction and the radial direction.

The first shaft 1 and the second shaft 11 are rotatably mounted relative to a housing 21, so that when a driver of the car turns the steering wheel both the first shaft 1 and the second shaft 11 rotate relative to the housing 21. In particular, in this embodiment the range of rotational movement of the first and second shafts is two full revolutions, i.e. 720°, relative to the housing 21.

In this embodiment, the steering mechanism is an electronic power-assisted steering mechanism in which electrical motors apply an assisting force which varies in dependence on the torque applied to the steering wheel by the driver. Accordingly, the torque applied by the driver must be monitored.

The torque applied to the steering wheel by the driver is transferred to the gear via the locking pin 19 which fixes the first shaft 1 to the second shaft 11. However, the axial distance between the locking pin 19 and the junction between the stepped region 9 of the first shaft 1 and the open end 17 of the second shaft 11 results in a relative rotary displacement between the stepped region 9 and the open end 17 which varies in dependence on the applied torque. According to the invention, an inductive sensor measures the relative rotary displacement between the stepped region 9 and the open end 17, and the applied torque is calculated from the measured relative rotary displacement.

The inductive sensor of the present invention has: an aerial member 23 which is mounted on an aerial guide 25 which is fixed relative to the housing 21; a first intermediate coupling element 27 (not shown in FIG. 1) which is mounted on a first sleeve member 29 which is fixed relative to the first shaft 1; and a second intermediate coupling element 31 which is mounted on a second sleeve member 33 which is fixed relative to the second shaft 11. The aerial member 23 has formed thereon a transmit aerial (not shown in FIG. 1) which generates a magnetic field which varies around the circumference of the first shaft 1 and the second shaft 11, and a receive aerial (not shown in FIG. 1). The transmit aerial is balanced relative to the receive aerial so that in the absence of the first intermediate coupling element 27 and the second intermediate coupling element 31 no nett signal would be induced in the receive aerial by virtue of the magnetic field generated by the transmit aerial, but in the presence of the first intermediate coupling element 27 and the second intermediate coupling element 31 a signal is induced in the receive aerial which depends on the rotary positions of the first shaft 1 and the second shaft 11.

In this embodiment, for improved safety the inductive sensor has two independent sensing arrangements providing respective readings for the relative rotary displacement of the first shaft 1 and the second shaft 11. In this way, if one sensing arrangement fails a measurement of the torque may still be calculated using the relative rotary displacement reading provided by the other sensing arrangement. As shown in FIG. 1, the inductive sensor has two ASICs 35a, 35b, with each ASIC 35 being used by a respective different one of the two sensing arrangements.

FIG. 2 schematically shows the main components of the torque sensing circuitry. In FIG. 2, the first sensing arrangement 41a and the second sensing arrangement 41b are schematically indicated by dashed boxes.

Each independent sensing arrangement 41 has two associated excitation windings 43 (performing the transmit aerial function for that sensing arrangement) and one sensor winding 45 (performing the receive aerial function for that sensing arrangement). In particular, the first sensing arrangement 41 has first and second excitation windings 43a and 43b and a first sensor winding 45a which are formed on the aerial member 23 and are connected to the first ASIC 35a. The first sensing arrangement also has a first resonant circuit 47a which is formed on the first intermediate coupling element 27 and a second resonant circuit 47b which is formed on the second intermediate coupling element 31. Similarly, the second sensing arrangement 41b has third and fourth excitation windings 43c and 43d and a second sensor winding 45b which are formed on the aerial member 23 and are connected to the second ASIC 35b, a third resonant circuit 47c which is formed on the first intermediate coupling element 27 and a fourth resonant circuit 47d which is formed on the second intermediate coupling element 31.

In this embodiment, for the first sensing arrangement 41a the first and second excitation windings produce radial magnetic field components which vary through twenty cycles of the sine and cosine functions respectively around a full circumference, and the third and fourth excitation windings produce radial magnetic field components which vary through nineteen cycles of the sine and cosine functions respectively around a full circumference. The radial magnetic field components induce a signal in the first resonant circuit 47a which varies in accordance with the rotary position of the first shaft 1, and induce a signal in the second resonant circuit which varies in accordance with the rotary position of the second shaft 11. The signals induced in the first and second resonant circuits 47a, 47b induce corresponding signal components in the first sensor winding 45a which are processed by the first ASIC 35a to determine the relative rotary displacement between the first shaft 1 and the second shaft 11. The second sensing arrangement 41b works in an analogous manner.

The ASIC 35 of each sensing arrangement outputs the calculated relative rotary displacement to a central control unit 49 of the car, which processes the relative rotary displacements to calculate the torque applied to the steering wheel.

FIG. 3 schematically shows a perspective view of the aerial member 23 and the aerial guide 25. As shown, the aerial guide 25 is a cylindrical sleeve having an outer surface with a recessed circumferential portion in which the aerial member 23 is fixedly mounted. In this embodiment, the aerial member 23 is a rectangular sheet of two-layer flexible printed circuit board (PCB) material having a length which is longer than the circumference of the recessed portion of the aerial guide 25. The aerial member 23 has conductive tracks deposited on either side which are connected, using via holes, to form the excitation windings 43 and the sensor windings 45. Two sets of six electrical contacts 51 are provided, with each set of six electrical contacts 51 connecting the two excitation windings and the sensor winding of a sensing arrangement with the corresponding ASIC 35.

FIG. 4 is a schematic plan view of the aerial member 23 when laid out flat, in which the conductive tracks formed on one side of the PCB are represented by solid lines whereas the conductive tracks formed on the other side of the PCB are represented by dashed lines. As shown in FIG. 3, the conductive tracks 61 associated with the first sensing arrangement 41a are spaced apart from the conductive tracks 63 associated with the second sensing arrangement 41b in the widthwise direction of the PCB (which corresponds to the axial direction when the aerial member 23 is mounted on the aerial guide 25).

In this embodiment, the excitation windings 43 and the sensor winding 45 for each sensing arrangement 41 include planar coil arrangements which extend over a length 65 of the PCB corresponding to the circumference of the recessed portion of the aerial guide 25. The excitation windings produce magnetic fields having a magnetic field component perpendicular to the PCB which varies in accordance with multiple periods of the sine function and the cosine function respectively in substantially the same manner as the excitation windings described in UK Patent Application GB 2374424A (the whole contents of which are hereby incorporated herein by reference). Further, in this embodiment the sensor winding of a sensing arrangement is formed by a multi-loop planar coil extending around the whole of the length 61.

FIG. 5 schematically shows a perspective view of the first intermediate coupling element 27 and the first sleeve member 29. As shown, the first sleeve member 29 has a cylindrical recess 71 for receiving the first shaft 1. The first sleeve member 29 also has a guide portion 73 on which the first intermediate coupling element 27 is mounted. The guide portion 73 has two opposing arc portions 75a and 75b, which are centred on the axis of the cylindrical recess 71, and two opposing connecting portions 77a and 77b which interconnect the two arc portions 75a, 75b.

FIG. 6 shows a plan view of the first sleeve member 29 (i.e. looking along the axial direction when mounted to the first shaft 1) showing the cylindrical recess 71 and the guide portion 73. As shown, the opposing arc portions 75a, 75b each extend approximately 70° around the cylindrical recess 71, and the connecting portions 77a, 77b extend inside of the circle of which the outer surfaces of the two arc portions 75 form part of the circumference.

Returning to FIG. 5, the two arc portions 75 include projecting parts causing the arc portions 75 to have approximately twice the axial extent of the two connecting portions 77. In this way, the side of the first sleeve member 29 including the projecting parts has a castellated appearance.

The first intermediate coupling arrangement includes a two-layer flexible PCB 79 having conductive tracks deposited on either side which are interconnected by via holes to form the inductors for the first and third resonant circuits 47a, 47c. FIG. 7 shows a schematic plan view of the flexible PCB 79 when laid out flat, with conductive tracks on one side of the PCB 79 being represented by solid lines and conductive tracks on the other side of the PCB 79 being represented by dashed lines.

As shown in FIG. 7, the PCB 79 has two end parts 91a, 91b, whose dimensions match the dimensions of respective arc portions 75 of the guide portion 73, and a connecting part 93 which is of reduced width and interconnects the two end parts 91. The connecting part 93 separates the two end parts 91 by a distance which allows the two end parts 91 to be mounted to the outer surface of the two arc portions 75 of the guide portion 73, with the connecting part 93 itself being mounted to one of the connecting portions 77 of the guide portion 73 (as shown in FIG. 4).

The inductor for the first resonant circuit 47a is formed by the serial connection of eight periodically-spaced current loop structures 95a-95h and the inductor for the third resonant circuit 47c is formed by the serial connection of seven periodically-spaced current loop structures 97a-97g. The current loop structures 95, 97 are arranged so that, when mounted to the sleeve member 29 as shown in FIG. 5, the current loops 95 for the first resonant circuit 47a are spaced apart in the axial direction from the current loops 97 of the third resonant circuit 47c. In particular, the axial spacing between the current loops for the first and third resonant circuits 47a, 47c equals the axial spacing between the excitation/sensor windings for the first sensing arrangement 41a and the excitation/sensor windings for the second sensing arrangement 41b.

As shown in FIG. 7, the current loop structures 95,97 are formed in the end parts 91 of the flexible PCB 79. Two terminals 99a and 99b are formed in the connecting part 93 of the flexible PCB 79 to which a capacitor (not shown) is mounted to form the first resonant circuit 47a with the inductor formed by the current loop structures 95, and two terminals 101a and 101b are formed in the connecting part 93 of the flexible PCB 79 to which a capacitor is mounted to form the third resonant circuit 47c with the inductor formed by the current loop structures 97. The current loop structures 95 for the first resonant circuit 47a are mounted adjacent the projecting parts of the first sleeve member 29.

In this embodiment, the first resonant circuit has a resonant frequency of 3.75 MHz and the third resonant circuit has a resonant frequency of 5 MHz. Further, the periodic spacing of the current loop structures 95 for the first resonant circuit 47a corresponds to an angular spacing of 18° (that is 360° divided by twenty), and the period spacing of the current loop structures 97 for the third resonant circuit 47c corresponds to an angular spacing of 18.95° (that is 360° divided by nineteen).

FIG. 8 schematically shows a perspective view of the second intermediate coupling element 31 and the second sleeve member 33. As shown, the second sleeve member 33 has a substantially identical castellated shape to the first sleeve member 29.

The second intermediate coupling element 33 is formed by a two-layer flexible PCB 111 in a similar manner to the first intermediate coupling element 29. FIG. 9 schematically shows a plan view of the flexible PCB 111 when laid out flat with the conductive tracks on one side being represented by solid lines and the conductive tracks on the other side being represented by dashed lines. Eight current loop structures 113a to 113h in the end portions of the flexible PCB 111 are connected in series with a capacitor (not shown) connected between terminals 115a and 115b to form the second resonant circuit 47b, which in this embodiment has a resonant frequency of 1.875 MHz, and seven current loop structures 117a to 117g in the end portions of the flexible PCB 111 are connected in series with a capacitor (not shown) connected between terminals 119a and 119b to form the fourth resonant circuit 47d, which in this embodiment has a resonant frequency of 2.5 MHz.

The periodic spacing of the current loop structures 113 for the second resonant circuit 47b corresponds to an angular spacing of 18° (that is 360° divided by twenty), and the periodic spacing of the current loop structures 117 for the fourth resonant circuit corresponds to an angular spacing of 18.95° (that is 360° divided by nineteen). The current loop structures 117 for the fourth resonant circuit 47d are mounted adjacent the projecting parts of the second sleeve member 33.

FIG. 10 schematically shows a perspective view of the positional relationship between the first intermediate coupling element 27 and the second intermediate coupling element 31 when the coupling arrangement is assembled. As shown, the castellated ends of the first and second sleeve members interlock so that the projecting parts of the arc portions 75 of one sleeve member are located in the spaces adjacent the outside of the connecting portions 77 of the other sleeve member. In this way, the current loop structures of the first resonant circuit 47a are in the same position along the axial direction as the current loop structures of the second resonant circuit 47b but are spaced apart in the circumferential direction. Similarly, the current loop structures of the third resonant circuit 47c are in the same position along the axial direction as the current loop structures of the fourth resonant circuit 47d but are spaced in the circumferential direction.

FIG. 11 schematically shows an exploded view indicating how the first sleeve member 29 and the second sleeve member 31 are received in the aerial guide 25, and FIG. 12 shows schematically shows the first sleeve member 29 and the second sleeve member 31 when positioned within the aerial guide 25. When assembled, the first sleeve member 29 and the second sleeve member 33 are rotatably mounted within the aerial guide 25, with the current loop structures of the first and second resonant circuits 47a, 47b located in the same position along the axial direction as the first and second excitation windings 43a, 43b and the first sensor winding 45a, and the current loop structures of the third and fourth resonant circuits 47c, 47d located in the same position along the axial direction as the third and fourth excitation windings 43c, 43d and the second sensor winding 45b.

FIG. 13 schematically shows the main components of the first ASIC 35a. A first quadrature signal generator 151a generates a quadrature pair of signals which in this embodiment have a frequency of 5 kHz (hereafter called the modulation frequency). A second quadrature signal generator 151b generates a quadrature signal at a first carrier frequency which is equal to the resonant frequency of the first resonant circuit 47a, which in this embodiment is 3.75 MHz. A third quadrature signal generator 151c generates a quadrature signal at a third carrier frequency which is equal to the resonant frequency of the second resonant circuit 47b, which in this embodiment is 1.875 MHz.

The quadrature pair of signals at the modulation frequency are input to a first modulating arrangement 153a which modulates the in-phase signal I₁ at the modulation frequency by the in-phase signal at the first carrier frequency to generate a signal I₁(t) and modulates the quadrature signal at the modulation frequency by the in-phase signal I₁ at the first carrier frequency to generate a signal Q₁(t). The quadrature pair of signals at the modulation frequency are also input to a second modulating arrangement 153b which modulates the in-phase signal at the modulation frequency by the in-phase signal I₂ at the second carrier frequency to generate a signal I₂(t) and modulates the quadrature signal at the modulation frequency by the in-phase signal I₂ at the second carrier frequency to generate a signal Q₂(t).

The signals I₁(t) and I₂(t) are then input into a first digital mixer 155a which combines the signals I₁(t) and I₂(t), and the resultant combined signal is amplified by a first coil driver 157a. The amplified signal output by the first coil driver 157a is supplied to the first excitation winding 43a. The signals Q₁(t) and Q₂ (t) are input to a second digital mixer 155b and the resultant combined signal is amplified by a second coil driver 157b and supplied to the second excitation winding 43b.

The signal components supplied to the first and second excitation windings 43a, 43b at around the first carrier frequency induce a resonant signal in the first resonant circuit 47a which varies in accordance with the radial position of the first shaft 1. The resonant signal induced in the first resonant circuit 47a in turn induces a signal in the first sensor winding 45a. Similarly, the signal components 3Q supplied to the first and second excitation windings 43a, 43b at around the second carrier frequency induce a resonant signal in the second resonant circuit 47b, which in turn induces a signal in the first sensor winding 45a.

As set out in UK Patent Application GB 2374424A, when the signal induced in the first sensor winding 45a is input into a first synchronous detector 159a which performs synchronous detection using the quadrature signal Q₁ at the first carrier frequency, the resultant signal output by the first synchronous detector 159a has a component at the modulation frequency whose phase depends on the angular position of the first shaft 1. This phase is detected by a first phase detector 161a. Similarly, when the signal induced in the first sensor winding 45a is input into a second synchronous detector 159b which performs synchronous detection using the quadrature signal Q₂ at the second carrier frequency, the resultant signal output by the second synchronous detector 159b has a component at the modulation frequency whose phase depends on the angular position of the second shaft 11. This phase is detected by a second phase detector 161b.

FIG. 14 shows a graph indicating the relationship between the phase detected by the first phase detector 161a and the angular position of the first shaft 1. As a result of the twenty periods of the excitation windings over a full revolution, as shown in FIG. 14 the phase detected by the first phase detector 161a corresponds to twenty different absolute rotary positions of the first shaft 1. Similarly, the phase detected by the second phase detector 161b corresponds to twenty different rotary positions of the second shaft 11. The first ASIC 35a is therefore unable to determine the absolute rotary positions of the first and second shafts 1,11 (in this specification absolute rotary position refers to the rotary position of a shaft relative to a reference position; as the shafts can rotate around two full revolutions the absolute position does not unambiguously give the position of a shaft within its entire rotary range of movement).

Despite the first and second shafts 1, 11 being able to rotate over a range of approximately 720°, the relative rotary displacement between the first and second shafts 1, 11 is never more than a few degrees, which is well within one period of the readings. A processor 163 is therefore able to calculate and output the relative rotary displacement between the first and second shafts 1, 11, thereby allowing the torque to be calculated by the central control unit 49.

In the second sensing arrangement 41b, the second ASIC 35b is substantially identical to the first ASIC 35a except that the first carrier frequency is set to 5 MHz and the second carrier frequency is set to 2.5 MHz. As discussed, the periodicity of the excitation windings and the resonant circuits in the second sensing arrangement 41b corresponds to nineteen periods over 3600. Therefore, as shown in FIG. 15, each phase reading corresponds to nineteen possible rotary positions. Again, as for the first sensing arrangement 41a although ambiguity exists in the absolute position measurement using the second sensing arrangement 41b, the range of relative rotary displacement between the first shaft 1 and the second shaft 11 is significantly less than one period and accordingly the relative rotary displacement may be unambiguously calculated.

In this embodiment, the ASIC 35 of each sensing arrangement 41 outputs the respective calculated relative rotary displacement to a central control unit 49 of the car, and also outputs the detected phase angles to the central control unit 49 of the car. The central control unit 49 calculates the torque using the calculated relative rotary displacement. Further, although each individual detected phase angle can not be converted unambiguously to an absolute position measurement, due to the difference between the periodicity of the first sensing arrangement 41a and the second sensing arrangement 41b the central control unit 49 is able to determine an absolute position measurement using the phase readings form both sensing arrangements 41 using a Vernier-type calculation.

The particular arrangement of the excitation windings 43, sensor windings 45 and resonant circuits 47 of the illustrated embodiment has a number of advantages. In particular:
(1) By using plural periodically-spaced current loop structures in the resonant circuits the signal induced in each resonant circuit is increased in comparison with a resonant circuit having a single current loop structure.
(2) By arranging the current loop structures in a circumferential plane with each current loop structure having an opposing current loop structure, the sensitivity to any ambient electromagnetic field is reduced. Further, the sensitivity to slight misalignments, between the axis of rotation of the shafts and the centre of the circular path of the transmit and receive aerials is reduced. In addition, such a cylindrical geometry gives an increased tolerance to axial misalignment between the transmit/receive aerials and the resonators.
(3) By circumferentially spacing apart the current loops associated with each resonator in each sensing arrangement, noise caused by coupling between adjacent resonant circuits is reduced.
(4) By axially spacing the excitation windings, sensor winding and current loop structures of the resonant circuits for the first sensing arrangement from the excitation windings, sensor winding and current loop structures of the resonant circuits for the second sensing arrangement, noise caused by coupling between the sensing arrangements is reduced.
(5) By employing the described castellated arrangement, it has been found that the performance for a given axial distance over which the inductive sensor extends is improved.

### MODIFICATIONS AND FURTHER EMBODIMENTS

As stated above, using plural periodically-spaced current loop structures in the resonant circuits has the advantage of increasing signal strength. While in the illustrated embodiment the periodic spacing of the current loop structures matches the period of the corresponding transmit aerial, the period of the resonant circuits could be any integer multiple of the period of the corresponding transmit coil.

It is not essential to use a plurality of current loop structures in each resonant circuit, and alternatively each resonant circuit could be formed by a single current loop structure.

In the illustrated embodiment, the excitation windings, the sensor windings and the current loop structures of the resonant circuits are arranged on circumferential surfaces, leading to advantage (2) above. However, this is not essential and the excitation windings, sensor windings and current loop structures could, for example, be formed on radial surfaces. In an embodiment, the radial surfaces for the current loop structures are provided by the surfaces of disks attached co-axially to the first and second shafts.

While the axial spacing of the sensing arrangements is preferred, it is not essential. In an alternative embodiment, the current loop structures for the first and third resonant circuits (which rotate with the first shaft) are located on the first shaft at a common axial position and the current loop structures for the second and fourth resonant circuits (which rotate with the second shaft) are located on the second shaft at a common axial position which is spaced axially apart from the common axial position of the first and third resonant circuits. In this alternative embodiment, the transmit aerials and receive aerials for the first and second sensing arrangements extend over an axial extent encompassing all the current loop structures. One advantage of such an arrangement is that it does not require interlocking castellated portions, and accordingly a full range of relative rotary displacement from −180° to +180° can be measured. Further, the current loop structures for resonant circuits formed in the same axial position need not be circumferentially spaced apart, and in an embodiment the resonant circuits could be formed by respective series of current loops which extend entirely around the respective shaft.

In the illustrated embodiment, in each sensing arrangement the associated resonant circuits are simultaneously energised, and the resultant signals induced in the sensor winding input into parallel processing paths to allow the phase angles at the modulation frequency associated with each resonant circuit to be measured in parallel. Alternatively, the resonant circuits could be alternately energised and the resultant signal induced in the sensor winding input into a single processing path in which the frequency of the synchronous detection is alternated in accordance with the energised resonant circuit.

In the illustrated embodiment, the excitation signal generating and sensed signal processing circuitry employs the general principles disclosed in GB 2374424A. However, alternative forms of excitation signal generating and sensed signal processing could be employed. For example, instead of having two excitation windings in the transmit aerial and detecting the phase of a signal induced in receive aerial formed by a single sensor winding, the transmit aerial could be formed by a single excitation winding and the receive aerial could be formed by two sensor windings, with the coupling between the excitation winding and the two sensor windings varying with rotary position. The general principles of such a rotary encoder are discussed in WO 95/31696.

In the described embodiment, carrier frequencies from 1.875 MHz to 5 MHz are used. It will be appreciated that the exact values of the carrier frequencies (and accordingly the resonant frequencies of the resonant circuits) is a design choice, although preferably the carrier frequencies are in the range 100 kHz to 10 MHz to achieve good signal coupling with comparatively cheap excitation and synchronous detection circuitry. The modulation frequency is also a design choice.

In the illustrated embodiment, the two sensing arrangements have a periodicity of twenty periods over 360° and nineteen periods over 360° respectively to enable absolute position measurement be carried out. It will be appreciated that alternative periodicities could be used. Further, if absolute position measurement was not required then the periodicities for the first and second sensing arrangements could be identical.

While in the illustrated embodiment absolute position measurement is obtained only with reference to the housing, it will be appreciated that the absolute position within the entire range of rotary movement could be measured by either employing an extra sensor to count revolutions or by continuously monitoring the rotary position in order to keep track of the revolutions.

Although separate ASICs are used for the two sensing arrangements in the illustrated embodiment for safety reasons, this is not essential and in many applications a common ASIC could be used for both sensing arrangements while still satisfying safety requirements. In some applications, the redundant sensing arrangement is not necessary and the redundant sensing arrangement accordingly need not be included.

In the illustrated embodiment, the output of each ASIC is representative of the relative rotary displacement between the first and second shafts and the central control unit determines the applied torque. It will be appreciated that the ASIC could perform linearisation and/or calibration processing. In an alternative embodiment, the ASIC could determine the applied torque. In another alternative embodiment, the output of each ASIC is representative of the detected phase angles associated with the first and second shafts, and the central control unit calculates both the relative rotary displacement and the applied torque.

It will be appreciated that there are many conventional signalling systems which could be used to transfer data between the ASICs and the central control unit, e.g. pulse width modulation or pulse code modulation.

Although ASICs are used in the illustrated embodiment, this is not essential and any other processing means could be employed, including using discrete electronic components.

In the illustrated embodiment, the aerials and resonant circuits are formed using PCB technology. This is not essential and other techniques for arranging conductive tracks, including arranging wire tracks, could alternatively be used.

In the illustrated embodiment, the torque sensor measures the torque applied to a steering wheel of a car. It will be appreciated that there are many other places in a car where a torque is applied and the inductive sensor according to the invention could be used. For example, the torque applied to a drive shaft could be measured. Further, the inductive torque sensor of the present invention also has application outside of the automotive industry. For example, the inductive sensor of the present invention could be used to measure the torque applied to a drill.

In the illustrated embodiment, a torsion bar arrangement is used in which two bars are fixed to each other, and relative rotary movement between the two bars is measured. This is generally advantageous in applications where the torsion bar must be made of a stiff material. However, in other applications a less stiff material may be acceptable, in which case the twisting of a single bar could be measured. In other words, the relative rotary displacement between two axial positions of the same member could be measured.

1. Apparatus for generating rotary displacement information representative of the torsion applied to a torsion bar which is rotatable, relative to a housing, about an axis of rotation, the apparatus comprising:
a first resonator fixed relative to a first axial position of the torsion bar, the first resonator having a first resonant frequency;
a second resonator fixed relative to a second axial position of the torsion bar which is away from the first axial position, the second resonator having a second resonant frequency which is different from the first resonant frequency;
a transmit aerial fixed relative to the housing; and
a receive aerial fixed relative to the housing,
wherein at least one of the electromagnetic coupling between the transmit aerial and the first resonator and the electromagnetic coupling between the first resonator and the receive aerial varies with the rotary position of the torsion bar relative to the housing at said first axial position so that a signal induced in the receive aerial by a first resonant signal induced in the first resonator by an electromagnetic field produced by the transmit aerial varies with the rotary position of the torsion bar relative to the housing at said first axial position, and
wherein at least one of the electromagnetic coupling between the transmit aerial and the second resonator and the electromagnetic coupling between the second resonator and the receive aerial varies with the rotary position of the torsion bar relative to the housing at said second axial position so that a signal induced in the receive aerial by a second resonant signal induced in the second resonator by an electromagnetic field produced by the transmit aerial varies with the rotary position of the torsion bar relative to the housing at said second axial position.

2. Apparatus according to claim 1, wherein the transmit aerial is operable to generate an electromagnetic field which varies periodically along a rotary measurement path, and wherein at least one of the first and second resonators comprises two or more current loops angularly spaced in accordance with an integer multiple of the angular period of the transmit aerial.

3. Apparatus according to claim 1, wherein the transmit aerial, the receive aerial and the first and second resonators are formed by conductive windings arranged axially and circumferentially around the torsion bar.

4. Apparatus according to claim 3, wherein at least one of the transmit aerial, the receive aerial and the first and second resonators are formed on a flexible printed circuit board.

5. Apparatus according to claim 1, wherein said two or more current loops are circumferentially arranged with current loops generally facing each other from opposing sides of the torsion bar.

6. Apparatus according to claim 1, wherein the first resonator and the second resonator comprise current loops formed in circumferentially spaced portions of a common axial position.

7. Apparatus according to claim 1, wherein the first resonator and the second resonator are axially spaced from each other.

8. Apparatus according to claim 1, wherein the transmit aerial, the receive aerial and the first and second resonators are formed by conductive windings arranged radially and circumferentially around the torsion bar.

9. Apparatus according to claim 1, wherein said transmit aerial is a first transmit aerial and said receive aerial is a first receive aerial, and wherein the apparatus further comprises:
a third resonator fixed relative to a third axial position of the torsion bar, the third resonator having a third resonant frequency different from the first and second resonant frequencies;
a fourth resonator fixed relative to a fourth axial position of the torsion bar which is spaced away from said third axial position, the fourth resonator having a fourth resonant frequency which is different from the first, second and third resonant frequencies;
a second transmit aerial fixed relative to the housing; and
a second receive aerial fixed relative to the housing,
wherein at least one of the electromagnetic coupling between the second transmit aerial and the third resonator and the electromagnetic coupling between the third resonator and the receive aerial varies with the rotary position of the torsion bar relative to the housing at said third axial position so that a signal induced in the receive aerial by a third resonant signal induced in the third resonator by an electromagnetic field produced by the second transmit aerial varies with the rotary position of the torsion bar relative to the housing at said third axial position, and
wherein at least one of the electromagnetic coupling between the transmit aerial and the fourth resonator and the electromagnetic coupling between the fourth resonator and the receive aerial varies with the rotary position of the torsion bar relative to the housing at the fourth axial position so that a signal induced in the receive aerial by a fourth resonant signal induced in the fourth resonator by an electromagnetic field produced by the second transmit aerial varies with the rotary position of the torsion bar relative to the housing at the fourth axial position.

10. Apparatus according to claim 9, wherein the first and third resonators are formed by current loops in common circumferential portions relative to the torsion bar, with the current loops of the first resonator being axially spaced from the current loops of the third resonator, wherein the second and fourth resonators are formed by current loops in common circumferential portions relative to the torsion bar, with the current loops of the second resonator being axially spaced from the current loops of the fourth resonator.

11. Apparatus according to claim 10, wherein the first and third resonators are formed on extended regions of a first castellated member fixed to the torsion bar, wherein the second and fourth resonators are formed on extended regions of a second castellated member fixed to the torsion bar, and wherein the first and second castellated members interlock with each other while allowing at least some relative rotary displacement.

12. Apparatus according to claim 9, wherein the electromagnetic coupling between the first aerial and the first receive aerial via the first and second resonators varies with a first angular periodicity, and the electromagnetic coupling between the second transmit aerial and the second receive aerial via the third and fourth resonators varies with a second angular periodicity which is different from the first angular periodicity.

13. Apparatus according to claim 1, wherein the torsion bar comprises a first elongate shaft and a second elongate shaft whose longitudinal axes are aligned with the axis of rotation, wherein the first and second shafts are coupled at an axial position away from said first and second axial positions.

14. Apparatus according to claim 1, further comprising an excitation signal generator for supplying an excitation signal to the transmit aerial and a signal processor for processing the signal induced in the receive aerial.

15. Apparatus according to claim 14, wherein the excitation signal generator is operable to energise the first and second resonators simultaneously.

16. Apparatus according to claim 14, wherein the signal processor is operable to process signals induced in the receive aerial by the first resonator and the second resonator simultaneously.

17. Apparatus according to claim 14, wherein the excitation signal generator is operable to energise the first and second resonators alternately.

18. Apparatus according to claim 14, wherein the signal processor is operable to process alternately signals induced in the receive aerial by the first resonator and the second resonator.

19. Apparatus according to claim 14, wherein the signal processor is operable to generate a signal conveying information representative of the relative rotary displacement between said first and second axial positions of the torsion bar.

20. Apparatus according to claim 14, wherein the signal generator is operable to generate an excitation signal comprising a periodic carrier signal having a first frequency modulated by a periodic modulation signal having a second frequency, the first frequency being greater than the second frequency.

21. Apparatus according to claim 20, wherein the signal processor comprises a demodulator operable to demodulate the induced signal generated in the receive aerial to obtain a demodulated signal at the second frequency.

22. Apparatus according to claim 21, wherein the signal processor further comprises a phase detector operable to detect the phase of the demodulated signal at the second frequency.

23. An apparatus for providing rotary displacement information indicative of the torque applied to a torsion bar which is rotatable relative to a housing, in which the electromagnetic coupling between a transmit aerial fixed relative to the housing and a receive aerial fixed relative to the housing varies in dependence upon the rotary position of first and second resonators fixed relative to spaced axial positions of the torsion bar, wherein the first and second resonators have respective different resonant frequencies to enable the signal coupled between the transmit aerial and the receive aerial via the first resonator to be distinguished from the signal coupled between the transmit aerial and the receive aerial via the second resonator.
